(19) United States
(12) Patent Application Publication
(10) Pub. No.: US 2025/0194466 A1
(43) Pub. Date: Jun. 19, 2025

(54) SELF-PROPELLED HARVESTER

(71) Applicant: CLAAS Selbstfahrende Erntemaschinen GmbH, Harsewinkel (DE)

(72) Inventors: Patrick Schulze Vohren, Sassenberg (DE); David Nickel, Harsewinkel (DE); Sascha Dieckmeyer, Melle (DE); Maximilian Schröder, Gütersloh (DE); Matthias Gausmann, Osnabrück (DE)

(73) Assignee: CLAAS Selbstfahrende Erntemaschinen GmbH, Harsewinkel (DE)

(21) Appl. No.: 18/985,672

(22) Filed: Dec. 18, 2024

(30) Foreign Application Priority Data
Dec. 18, 2023 (DE) 10 2023 135 458.2

(51) Int. Cl. A01D 41/127; A01D 61/02; G06T 7/00

(52) U.S. Cl. CPC A01D 41/1272; G06T 7/0002; A01D 61/02; G06T 2207/30188; G06T 2207/30248

(57) ABSTRACT

An agricultural harvester. The agricultural harvester may comprise a self-propelled combine harvester having a control assembly that comprises an optical sensor device for recording image series of a continuous flow of harvested material, an evaluation device for determining a displayed value broken grain fraction and/or an displayed value non-grain fraction of the flow of harvested material based on an image analysis of the recorded image series, and a visualization device for displaying the displayed value broken grain fraction and/or the displayed value non-grain fraction. The harvester may further comprise a driver assistance system which includes an input unit and an adjustment assistant for adjusting a correction factor. The evaluation device may be configured to determine the displayed value broken grain fraction and/or displayed value non-grain fraction using the adjusted correction factor. Further, the adjustment assistant may determine the correction factor in a dialog with a plurality of dialog steps.

### CROSS REFERENCE TO RELATED APPLICATIONS

This application claims priority under 35 U.S.C. § 119 to German Patent Application No. DE 10 2023 135 458.2 filed Dec. 18, 2023, the entire disclosure of which is hereby incorporated by reference herein.

### TECHNICAL FIELD

The present invention relates to a self-propelled harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A self-propelled harvester may, for example, be designed as a combine harvester and may comprise a control assembly with a sensor device for recording one or more images of a flow of harvested material. Furthermore, the control assembly may comprise an evaluation device which initially determines a raw broken grain fraction and/or raw non-grain fraction with reference to the image area from one or more images. In a next step, this raw fracture grain fraction and/or raw non-grain fraction with reference to the image area is extrapolated to a volume-related displayed value fracture grain fraction or displayed value non-grain fraction by means of a correction factor. To extrapolate the raw broken grain fraction or the raw non-grain fraction to the volume-related displayed value broken grain fraction or displayed value non-grain fraction, the raw broken grain fraction or raw non-grain fraction is multiplied by the correction factor.

US Patent Application Publication No. 2015/0009328 A1, incorporated by reference herein in its entirety, discloses such a combine harvester. US Patent Application Publication No. 2015/0009328 A1 discloses that such a correction factor may be determined empirically (e.g., by measurements, and stored in a memory of the evaluation device).

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic side view of a combine as a proposed agricultural harvesting machine.

FIG. 2 illustrates a schematic side view of a grain elevator of the combine harvester of FIG. 1.

FIG. 3 illustrates bar chart for the representation of a displayed value broken grain fraction and a displayed value non-grain fraction.

FIG. 4 illustrates a dialog step for adjusting a correction factor.

FIG. 5 illustrates a dialog step for adjusting a correction factor.

FIG. 6 illustrates a dialog step for adjusting a correction factor.

### DETAILED DESCRIPTION

As discussed in the background, a correction factor may be used to determine the value for the broken grain fraction or the value for the non-grain fraction. However, a disadvantage of such a correction factor may be that the correction factor may vary depending on the harvested material. In addition, the surface broken grain fraction and the surface non-grain fraction or the corresponding raw broken grain fraction and raw non-grain fraction measured in the images may be subject to statistical conditions. Even within a crop type, the average grain sizes of the harvested material to be harvested may differ for different field crops. Consequently, the displayed value for the broken grain fraction and/or displayed value for the non-grain fraction determined from the raw broken grain fraction and/or raw non-grain fraction using the correction factor may deviate from the value for the real actual broken grain fraction and/or the value for the actual non-grain fraction.

For an operator, the correction factor may represent an abstract numerical value that he or she may hardly or not at all relate to the real conditions on a field to be worked. It may therefore be particularly challenging for the operator to make a corresponding adjustment to the correction factor if he or she detects a deviation between the displayed value broken grain fraction displayed to him or her and/or the displayed value non-grain fraction and the real actual broken grain fraction and/or the real actual non-grain fraction of the harvested material in the grain tank of the harvester.

Thus, a methodology is disclosed to simplify the adjustment of an evaluation device for determining a displayed value broken grain fraction and/or displayed value non-grain fraction.

In one or some embodiments, an agricultural harvester, such as a self-propelled combine harvester, is disclosed. The agricultural harvester includes: a control assembly comprising an optical sensor device configured to record and image series of a passing flow of harvested material (e.g., one or more images of the passing flow of harvested material); an evaluation device configured to determine one or both of a displayed value broken grain fraction or a displayed value non-grain fraction of the flow of harvested material based on an image analysis of the recorded image series (e.g., one or more images of the passing flow of harvested material); and a visualization device configured to display the displayed value broken grain fraction and/or the displayed value non-grain fraction. The harvester may further comprise a driver assistance system comprising an input unit and an adjustment assistant configured to adjust a correction factor, which may be configured to determine the value broken grain fraction that is displayed or output and/or displayed value non-grain fraction that is displayed or output. The adjustment assistant may be configured to determine the correction factor in a dialog with several dialog steps.

In one or some embodiments, the adjustment of the evaluation device using the adjustment assistant, which is configured to determine the correction factor in a dialog with the operator of the harvester, may enable the operator to adjust the agronomic target variable in the context of a dialog instead of directly adjusting an abstract variable or an abstract numerical value. This may make it considerably easier for the operator to adjust the evaluation device. The operator may evaluate the actual broken grain fraction and/or the actual non-grain fraction of an amount of harvested material in the grain tank. If the operator offers a negative assessment or a deviation from his expectations of the actual broken grain fraction and/or the actual non-grain fraction in the context of the dialog, an adjustment of the correction factor may be suggested in a further dialog step. The displayed value broken grain fraction and/or the displayed value non-grain fraction may be used by a control device of the harvester to adjust (such as automatically adjust) the implements, consequently resulting in an optimization of the actual broken grain fraction and/or the actual non-grain fraction from the adjustment (such as the automatic adjustment) of the displayed value broken grain fraction and/or the displayed value non-grain fraction.

In one or some embodiments, the evaluation device is configured to automatically determine a raw broken grain fraction and/or a raw non-grain fraction from the image series (e.g., the one or more images), and to automatically calculate a displayed value broken grain fraction and/or a displayed value non-grain fraction from the raw broken grain fraction and/or raw non-grain fraction.

In one or some embodiments, the raw broken grain fraction and/or the raw non-grain fraction may correspond to an area broken grain fraction and/or area non-grain fraction of at least one image of the image series, and the displayed value broken grain fraction and/or the displayed value non-grain fraction may correspond to a volume non-grain fraction and/or volume broken grain fraction related to throughput of at least a part of the flow of the harvested material, such as a main flow of harvested material.

In one or some embodiments, the visualization device (e.g., a touchscreen display) may be configured to display the value of the broken grain fraction and/or the value of the non-grain fraction. The visualization device may be configured to display the values in the form of a bar chart, wherein the bar chart may represent the value of the broken grain fraction and/or the value of the non-grain fraction. With this display, the operator may easily recognize whether the displayed value of the broken grain fraction and/or the displayed value of the non-grain fraction is within a permissible range.

In one or some embodiments, the dialog of the adjustment assistant may have a dialog step A, which may comprise the input of a target broken grain fraction and/or a target non-grain fraction. The target broken grain fraction and/or the target non-grain fraction may be a target specification for the harvested material accumulating in the grain tank during the harvesting process. A control device of the harvesting machine may adjust, such as automatically adjust, the parameters of the implements in such a way that the displayed value broken grain fraction and/or the displayed value non-grain fraction at least approximates the target broken grain fraction and/or the target non-grain fraction.

In one or some embodiments, the dialog of the adjustment assistant may have a dialog step B which may comprise a query of a target variable to be optimized, wherein the actual broken grain fraction and/or the actual non-grain fraction may be selected as the target variable. If the operator of the harvester is dissatisfied with the actual broken grain fraction and/or the actual non-grain fraction of the harvested material in the grain tank, he or she may easily select a target variable to be improved in the context of dialog step B.

In one or some embodiments, the dialog of the adjustment assistant may have a dialog step C which may comprise an evaluation of the actual broken grain fraction and/or the actual non-grain fraction of an amount of harvested material located in a grain tank. So that the assessment of the actual broken grain fraction and/or actual non-grain fraction may be made particularly simple, the operator may divide the actual broken grain fraction and/or the actual non-grain fraction into quality classes in dialog step C, such as into five quality classes.

In one or some embodiments, the dialog of the adjustment assistant may have a dialog step D which may comprise a suggestion for the correction factor to be adjusted, wherein the suggestion for the correction factor to be adjusted may be based on the assessment of the actual broken grain fraction and/or the actual non-grain fraction of the crop located in the grain tank.

In one or some embodiments, the dialog of the adjustment assistant may have a dialog step E in which an operator may confirm the suggestion displayed to him or her for the correction factor to be adjusted (e.g., the correction factor may be output on the display as a suggestion to the operator for approval and/or rejection). In this regard, the evaluation device may use or reject the suggested correction factor for calculating the displayed value broken grain fraction and/or the displayed value non-grain fraction.

In one or some embodiments, the agricultural harvester may comprise at least one control device and one or more implements (e.g., a plurality of implements). The implements may comprise any one, any combination, or all of: at least one threshing unit; a separating device; or a cleaning device. The control device may be configured to control (e.g., automatically control) and/or regulate (e.g., automatically regulate) the implements in such a way that the displayed value broken grain fraction and/or the displayed value non-grain fraction may be approximated to the target broken grain fraction and/or the target non-grain fraction.

In one or some embodiments, the sensor device may have a transparent housing piece, which may be part of a wall surface of a tubular harvested material guide, such as a grain elevator.

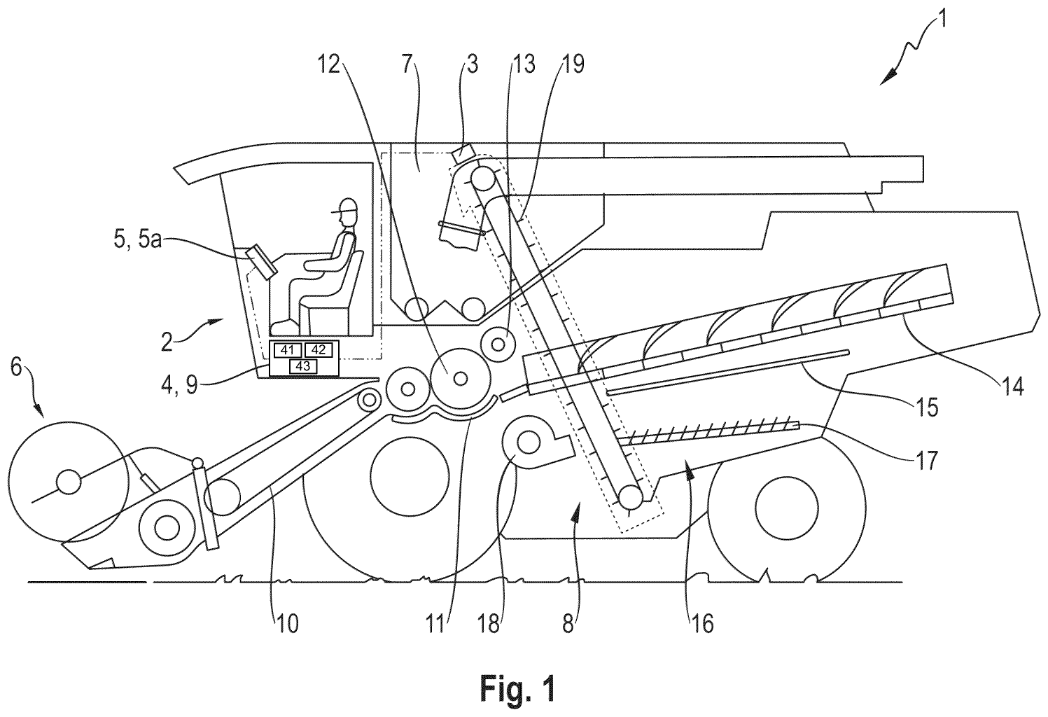

Referring to the figures, the agricultural harvester shown in FIG. 1, which may comprise a combine harvester 1 as illustrated, has a control assembly 2. This control assembly 2 comprises: an optical sensor device 3 configured to record image series (e.g., one or more images) of a passing main flow of harvested material; an evaluation device 4 configured to determine a displayed value broken grain fraction 20 (e.g., a value of the broken grain fraction to be displayed on a display) and/or a displayed value non-grain fraction 21 (e.g., a value of the broken non-grain fraction to be displayed on a display) of the main flow of harvested material based on a recorded image series, to be explained; and a visualization device 5 (e.g., a display device or a touchscreen device) configured to display the displayed value broken grain fraction 20 and/or the displayed value non-grain fraction 21. The displayed value broken grain fraction 20 may comprise the fraction, portion, percentage of the broken grains in the harvested material flow or the like for display. Likewise, the displayed value non-grain fraction 21 may comprise the fraction, portion, percentage of the non-grains in the harvested material flow or the like for display. As one example, the displayed value broken grain fraction 20 may comprise a value of the broken grain fraction to be displayed on a display, which may be calculated from one or both of the raw broken grain fraction or raw non-grain fraction, as discussed further below. As another example, the displayed value non-grain fraction 21 may comprise a value of the broken non-grain fraction to be displayed on a display, which may be calculated from one or both of the raw broken grain fraction or raw non-grain fraction, as discussed further below. The mode of operation of such a control assembly 2 is disclosed in US Patent Application Publication No. 2015/0009328 A1, which is incorporated by reference herein in its entirety.

In particular, in one or some embodiments, the evaluation device 4 and the visualization device 5 may be designed as separate electronic devices that are configured to communication with one another. Alternatively, the evaluation device 4 and the visualization device 5 may comprise a single electronic device. In one or some embodiments, an image series may comprise (or consists of) any series of individual images taken (such as sequentially taken at short intervals), wherein such image series may also comprise (or consist of) only a single image. In a particular embodiment, each image series may comprise (or consists of) a constant number of images.

In one or some embodiments, one or more images from the image series may also be selected for further evaluation, wherein the remaining images may also be discarded. In one or some embodiments, the time interval between the individual images of an image series may be defined as the intermediate image time, wherein the entire recording duration of the image series may then be referred to as the image series recording duration. In one or some embodiments, the intermediate image time may be constant. Alternatively, or in addition, the intermediate image time may be variable. Still alternatively, the intermediate image time may be both constant and variable. In one or some embodiments, the evaluation device 4 may adjust the intermediate image time. In one or some embodiments, a video recording may also be obtained, from which one or more individual still images may then be selected, which may thereby form the image series. In such a case, the intermediate image time results from the time offset between the individual images in an analog manner. The individual images in the image series may have different image parameters (e.g., any one, any combination, or all of: a different angular perspective; illumination time; image recording duration; or spectrum of the illumination light). The individual images may also have been recorded by a distributed sensor device 3 comprising (or consisting of) several individual sensor devices, wherein these images captured from different perspectives may also be combined to form a single image series.

In one or some embodiments, the term “flow of harvested material” of the harvester may be understood as the flow of the processed harvested material on the harvested material transport path of the harvester. In one or some embodiments, the harvested material transport path may begin specifically with the combine harvester 1 at the cutting unit 6 and may lead (such as may always lead) to the grain tank 7 of the combine harvester 1. The term “main flow of harvested material” may then refer to that part of the flow of harvested material which forms the predominant part of the harvested material in relation to the entire harvested material transport path. In other words, this does not necessarily mean a (partial) flow of harvested material that is moved through a potentially existing, smaller secondary branch of the harvested material transport path in the manner of a bypass.

In one or some embodiments, the term “broken grain fraction” or “non-grain fraction” may refer to the fraction of broken grains in all grains in the flow of harvested material on the one hand and the fraction of material in the flow of harvested material that is not grain in the sense of harvested material on the other. The non-grain fraction may therefore also include material that in fact is actually grain, but is not grain in the currently harvested material. In this case, the term “raw broken grain fraction” or “raw non-grain fraction” may refer to a broken grain fraction or non-grain fraction recorded in an image area of the image series.

In one or some embodiments, the operator of the harvester is shown a volume-related displayed value broken grain fraction 20 and/or a displayed value non-grain fraction 21 in a manner to be explained in more detail below. The determined displayed value broken grain fraction 20 and/or displayed value non-grain fraction 21 may be based on any one, any combination, or all of: a single image of the image series; on the entire image series; or on a special selection of one or more images of the image series. One or more images may be selected from the image series, which may represent the best image according to a quality criterion. Such a quality criterion may be a particularly suitable brightness, contour or contrast distribution.

In one or some embodiments, the evaluation device 4 is configured to perform an image analysis of the image series or a part of the image series in which first broken grains and non-grains may be automatically recognized in the image using suitable algorithms. The area occupied by the broken grains and non-grains in the two-dimensional image may then be automatically calculated as an area ratio, wherein the given area ratio may correspond to the raw broken grain fraction or the raw non-grain fraction. In the next step, the area ratio may be automatically extrapolated to a volume fraction using a suitable extrapolation function, and the displayed value broken grain fraction 20 or displayed value non-grain fraction 21 automatically displayed to the operator may be automatically determined.

In one or some embodiments, the control assembly 2 may automatically and cyclically record image series and may automatically display a current displayed value broken grain fraction 20 and/or displayed value non-grain fraction 21 based on the image series within a predetermined processing time after recording an image series. In one or some embodiments, the cycle of recording and/or determining and/or displaying may thus relate to the image series, wherein, for example, the time of recording the first image of the image series may be defined as the relevant time for determining the cyclicity. The above-defined image series recording duration may also be equal to the cycle time of the image series, which may correspond to a quasi-continuous recording of images without a noticeable pause between individual image series.

In one or some embodiments, the display of a displayed value broken grain fraction 20 and/or displayed value non-grain fraction 21 based on the image series after the recording of the image series within a predetermined processing time may also be understood as a real-time condition or real-time request. Accordingly, a processing time may be predetermined within which a displayed value broken grain fraction 20 and/or displayed value non-grain fraction 21 is displayed after recording an image series, wherein this displayed value broken grain fraction 20 and/or displayed value non-grain portion 21 may be based on the recorded image series. In other words, the maximum time between these two events (e.g., the running time between the recording of an image series and the display of a displayed value broken grain fraction 20 and/or displayed value non-grain fraction 21 based thereon) may be defined as the processing time within which the information in the recorded image series is reflected in the depicted displayed value broken grain fraction and/or displayed value non-grain fraction. If, a displayed value broken grain fraction 20 and/or displayed value non-grain fraction 21 based on the image series is then displayed for each recorded image series, then the displayed displayed value broken grain fraction 20 and/or displayed value non-grain fraction 21 may be updated cyclically in the same way as the image series is recorded.

In one or some embodiments, the harvester has automatically controllable implements 8 and the control assembly 2 has a control device 9 for adjusting (such as automatically adjusting) the parameters of the implements 8 based on the displayed value broken grain fraction 20 and/or the displayed value non-grain fraction 21. As also shown in combine harvester 1 in FIG. 1, the control and regulating device 9 may be arranged or positioned in the same implement as the evaluation device 4.

In one or some embodiments, the control and regulating device 9 and the evaluation device may include at least one processor 41, at least one memory 42, and at least one communication interface 43. The at least one processor 41 and at least one memory 42 may be in communication (e.g., wired and/or wirelessly) with one another. In one or some embodiments, the processor 41 may comprise a microprocessor, controller, PLA, or the like. Similarly, the memory 42 may comprise any type of storage device (e.g., any type of memory). Though the processor 41 and the memory 42 are depicted as separate elements, they may be part of a single machine, which includes a microprocessor (or other type of controller) and a memory. Alternatively, the processor 41 may rely on the memory 42 for all of its memory needs. Still alternatively, the processor 41 may rely on a database for some or all of its memory needs. The memory 42 may comprise a tangible computer-readable medium that include software that, when executed by the processor 41 is configured to perform any one, any combination, or all of the functionality described herein, such as the functionality of performing image analysis, automatically adjusting the parameters of the implements 8, adjust the correction factor 26, or other automatic operation devices discussed herein. Further, the communication interface 42 may be configured to communicate (e.g., wired and/or wirelessly) with one or more electronic devices. As one example, the communication interface 43 may be configured to communicate with driver assistance system 22. Alternatively, any one, any combination, or all of the control and regulating device 9, the evaluation device 4, or driver assistance system 22 may be included within a single electronic device.

The processor 41 and the memory 42 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In the depicted combine harvester 1, the controllable implements 8 may include the previously mentioned cutting unit 6 and the inclined conveyor 10 connected thereto. From this, the flow of harvested material of the combine harvester 1 may be transferred to the threshing units 12 enclosed by the threshing concave 11. Via a deflection drum 13, the harvested material flow may enter into the separating device 14 designed in this case as a separating rotor in which freely mobile grains of the harvested material flow may be deposited in a lower area. From here, the harvested material flow may pass via the returns pan 15 to a cleaning device 16 that, as shown here, may comprise (or consist of) several screening levels 17 and a blower 18. From here, the grain elevator 19 may finally guide the harvested material flow to the grain tank 7.

The aforementioned implements 8 may be controlled (such as automatically controlled) and provide parameter adjustment. The relationship between the parameter adjustment of the implements 8 and the quality of the harvested material may be complex and may depend on the type of harvested material and/or on a large number of other boundary conditions. For example, if the threshing units 12 are operated too heavily, excessive breaking of grains in the harvested material may occur, and more energy may be consumed during threshing. On the other hand, too low a threshing intensity of the threshing units 12 may lead to a lower threshing volume and therefore to a lower yield.

Similarly, the parameter adjustment of the cleaning device 16 may be performed in such a way that, on the one hand, as many grains of the harvested material as possible continue along the harvest transport path, but conversely, impurities and other undesirable components are separated out. Even under known boundary conditions, the optimum parameter adjustment of the implements 8 represents a challenge. In one or some embodiments, automatic or semi-automatic control and parameter adjustment of the implements 8 may be performed by the control device 9 of the control assembly 2.

In one or some embodiments, the evaluation device 4 is configured to determine the raw broken grain fraction and/or raw non-grain fraction and an averaged displayed value broken grain fraction 20 and/or averaged displayed value non-grain fraction 21. In this case, the raw broken grain fraction and/or the raw non-grain fraction either has no averaging over time or in any case a lower, in particular averaging over time compared to the averaged displayed value broken grain fraction 20 and/or the averaged displayed value non-grain fraction 21. In one or some embodiments, the visualization device 5 is configured to display the displayed value broken grain fraction and/or displayed value non-grain fraction. Confusion by the operator from jumps in the display may therefore be avoided by performing averaging of the current displayed value broken grain fraction 20 and/or current displayed value non-grain fraction 21 that is displayed for the operator.

In one or some embodiments, the raw broken grain fraction and/or the raw non-grain fraction may be extrapolated to a throughput of the main flow of harvested material by relating a measured area broken grain fraction (e.g., an area of the broken grain fraction) and/or area non-grain fraction (e.g., an area of the non-grain fraction) from at least one image of the image series to a volume broken grain fraction or displayed value broken grain fraction 20 and/or a volume non-grain fraction or displayed value non-grain fraction 21 using a given correction factor. The correction factor may be different in each case for determining the broken grain fraction and the non-grain fraction. Such a correction factor, which may also be a function of the area broken grain fraction or the area non-grain fraction, may take into account the fact that the percentage area occupied by broken grains or non-grains in an image does not necessarily correspond to the percentage occupied volume of broken grains or non-grains in the main flow of harvested material. In this regard, the correction factor for the broken grain fraction may be dependent on one or both the area broken grain fraction or the area non-grain fraction. Similarly, the correction factor for the non-grain fraction may be dependent on one or both of the area non-grain fraction or the area broken grain fraction.

In one or some embodiments, the correction factor, which may be dependent on the crop, may be determined empirically (e.g. by measurements), and saved in the evaluation device 4. In order to obtain the displayed value broken grain fraction 20 or the displayed value non-grain fraction 21, the area broken grain fraction or the area non-grain fraction may be multiplied by the given correction factor. The extrapolation to the throughput of the main flow of harvested material may refer to the volume of the entirety of the main flow of harvested material as it is fed through the harvester and specifically the combine harvester 1. In one or some embodiments, the displayed value broken grain fraction 20 and/or the displayed value non-grain fraction 21, or the current volume broken grain fraction and/or the current volume non-grain fraction, is displayed as a percentage.

As previously indicated, the correction factor may vary depending on the harvested material. In addition, any one, any combination, or all of the surface broken grain fraction, the surface non-grain fraction, the corresponding raw broken grain fraction, or the corresponding raw non-grain fraction measured in the images may be subject to statistical conditions. Even within a crop type, the average grain sizes of the harvested material to be harvested may differ for different field crops. Consequently, the displayed value broken grain fraction 20 and/or displayed value non-grain fraction 21 determined from the raw broken grain fraction and/or raw non-grain fraction may deviate from the actual broken grain fraction 39 and/or actual non-grain fraction 40. In this case, the actual broken grain fraction 39 or the actual non-grain fraction 40 may correspond to the real broken grain fraction and/or real non-grain fraction, based on the volume, of an amount of harvested material in the grain tank 7. For this reason, the harvester may comprise a driver assistance system 22, to be explained in more detail, through which to adjust the correction factor 26, which in turn may be used to convert the raw broken grain fraction and/or raw non-grain fraction to the displayed value broken grain fraction 20 and/or the displayed value non-grain fraction 21. The driver assistance system 22 may comprise an input unit 24, which may serve to interact with the operator of the harvester. In one or some embodiments, the input unit 24 may be formed as part of the visualization device 5 (e.g., a touchscreen). Using the adjustment of the correction factor 26, the operator may adjust the displayed broken value broken grain fraction 20 and/or the displayed value non-grain fraction 21 displayed to him or her to the actual broken grain fraction 39 and/or actual non-grain fraction 40.

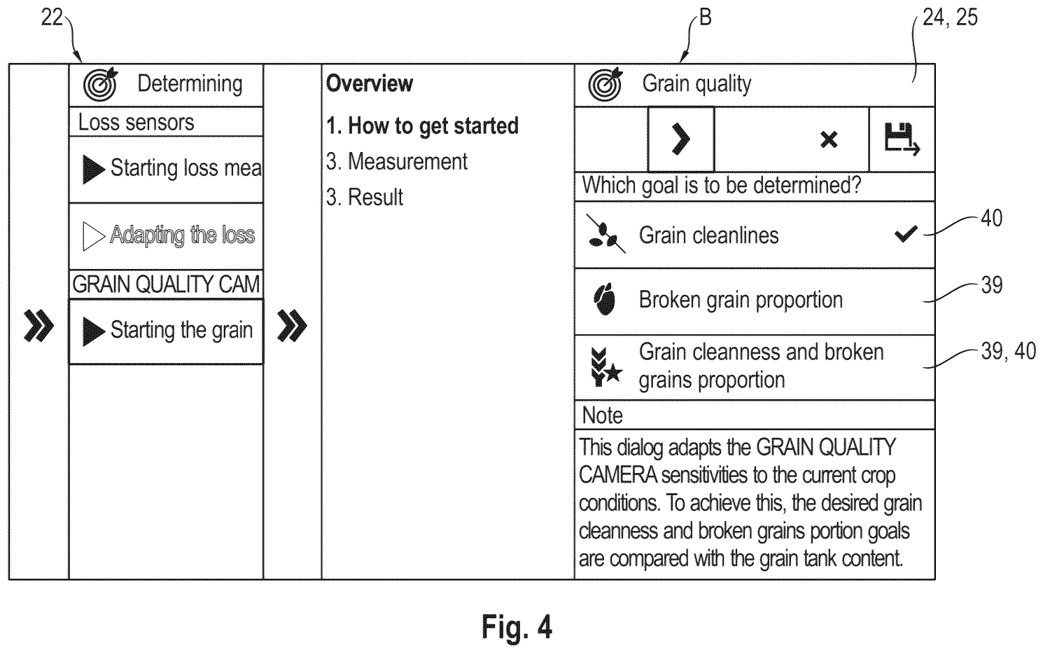

To adjust the correction factor 26, the driver assistance system 22 may comprise an adjustment assistant 25. As discussed above, the adjustment assistance may include a processor 41 and a memory 42. The adjustment assistant 25 may have a software program (stored in the memory 42) and executing on the processor 41. Example outputs of the adjustment assistant 25 are shown in FIGS. 4 to 6, by way of example. The adjustment assistant 25 may be configured to determine the correction factor 26 to be adjusted in a natural language dialog with one or more dialog steps.

In one or some embodiments, the dialog of the adjustment assistant 25 may comprise a dialog step A, not shown in detail here, in which the operator of the harvesting machine enters a target broken grain fraction 27 and/or a target non-grain fraction 28. The target broken grain fraction 27 and/or the target non-grain fraction 28 may be a target specification for the harvested material accumulating in the grain tank 7 during the harvesting process. The control device 9 may adjust the parameters of the implements 8 in such a way that the displayed value broken grain fraction 20 and/or the displayed value non-grain fraction 21 at least approximates the target broken grain fraction 27 and/or the target non-grain fraction 28.

In one or some embodiments, the dialog of the adjustment assistant 25 further includes a dialog step B shown in FIG. 4, which comprises a query of a target variable to be optimized, wherein the actual broken grain fraction 39 and/or the actual non-grain fraction 40 are selected as the target variable. If the operator of the harvester is dissatisfied with the actual broken grain fraction 39 and/or the actual non-grain fraction 40 of the harvested material in the grain tank 7, he or she may select the target variable to be improved in the context of dialog step B.

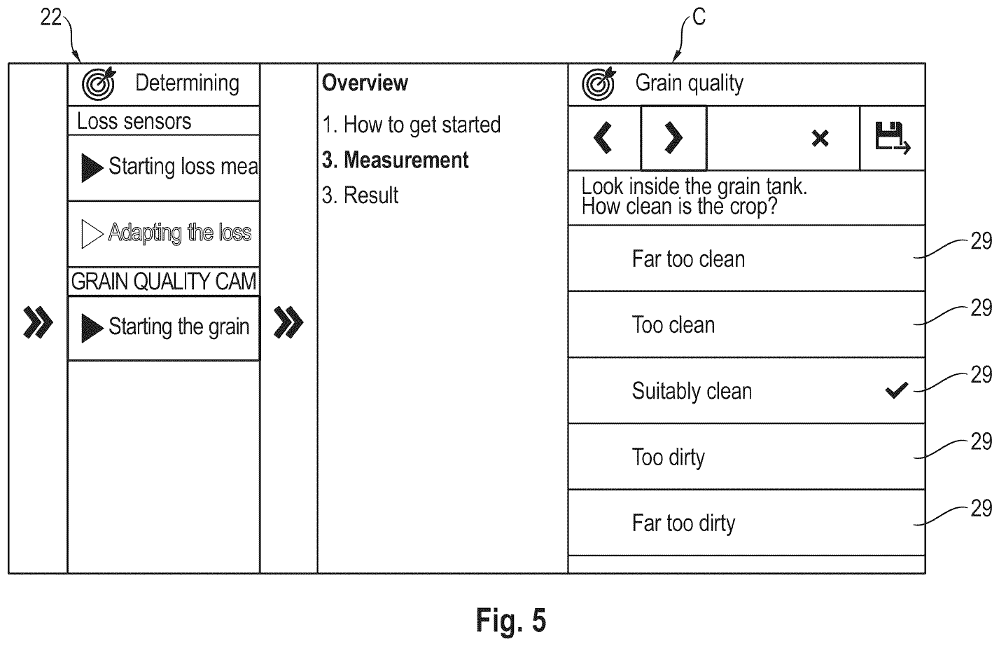

In one or some embodiments, the dialog of the adjustment assistant 25 may further include a dialog step C shown in FIG. 5, which comprises an evaluation of the actual broken grain fraction 39 and/or the actual non-grain fraction 40 of the amount of harvested material located in the grain tank 7. In one or some embodiments, in dialog step C, the operator may classify the actual broken grain fraction 39 and/or the actual non-grain fraction 40 into a plurality of classes, such as into at least three quality classes, or such as into five quality classes 29. As an example, five quality classes 29 for the actual non-grain fraction 40 are shown in FIG. 5. The quality classes 29 comprise a five-level selection from too much non-grain fraction 40 to too little non-grain fraction 40.

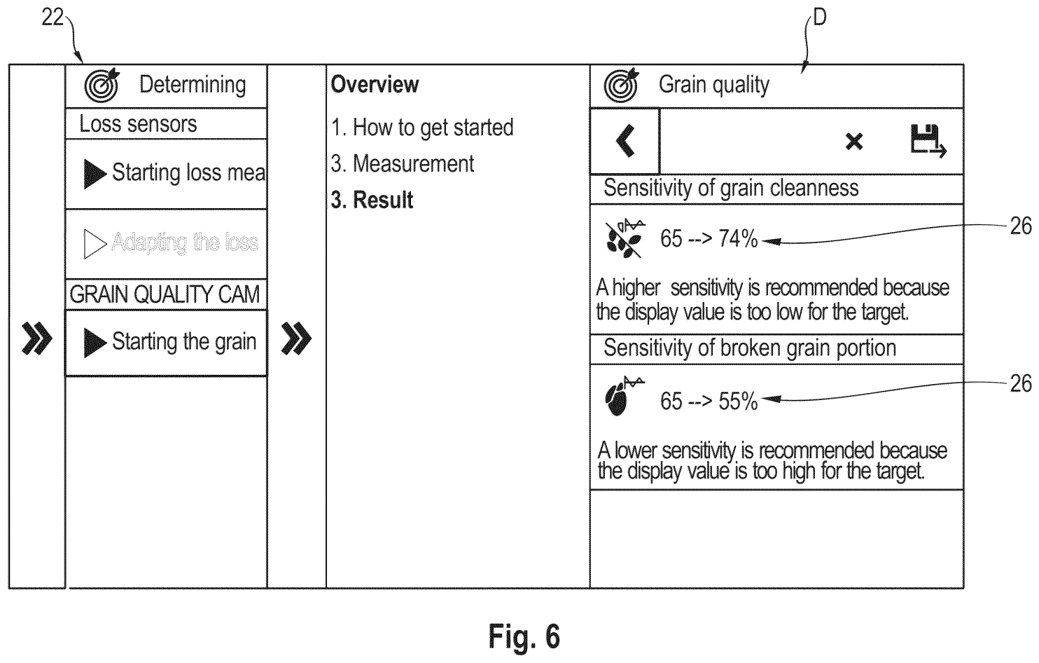

In one or some embodiments, the dialog of the adjustment assistant 25 further comprises a dialog step D shown in FIG. 6, which has a suggestion for the correction factor 26 to be adjusted, wherein the suggestion for the correction factor 26 to be adjusted may be based on the assessment of the actual broken grain fraction 39 and/or the actual non-grain fraction 40 of the crop in the grain tank 7. The operator may accept or reject the suggestion. Accepting the suggestion causes the correction factor for calculating the displayed value broken grain fraction 20 and/or the correction factor for calculating the displayed value non-grain fraction 21 to be adjusted. The control device 9 may automatically control or automatically regulate the working parameters of the implements 8 on the basis of the displayed value broken grain fraction 20 and/or the displayed value non-grain fraction 21. Consequently, with the adjustment of the correction factor, the implements 8 may be simultaneously controlled in such a way that the actual broken grain fraction 39 and/or the actual non-grain fraction 40 approach the target broken grain fraction 27 and/or the target non-grain fraction 28.

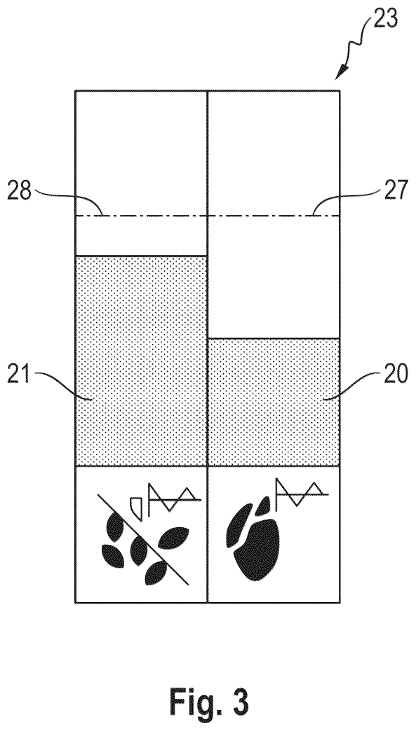

In one or some embodiments, for the display, the visualization device 5 may display a bar chart 23 shown in FIG. 3, wherein the bar chart 23 represents the displayed value broken grain fraction 20 and/or the displayed value non-grain fraction 21. At the same time, a marking corresponding to the target broken grain fraction 27 and the target non-grain fraction 28 may be shown in the bar chart 23, so that the operator is informed as to whether the determined displayed value broken grain fraction 20 and/or displayed value non-grain fraction 21 are within a permissible range.

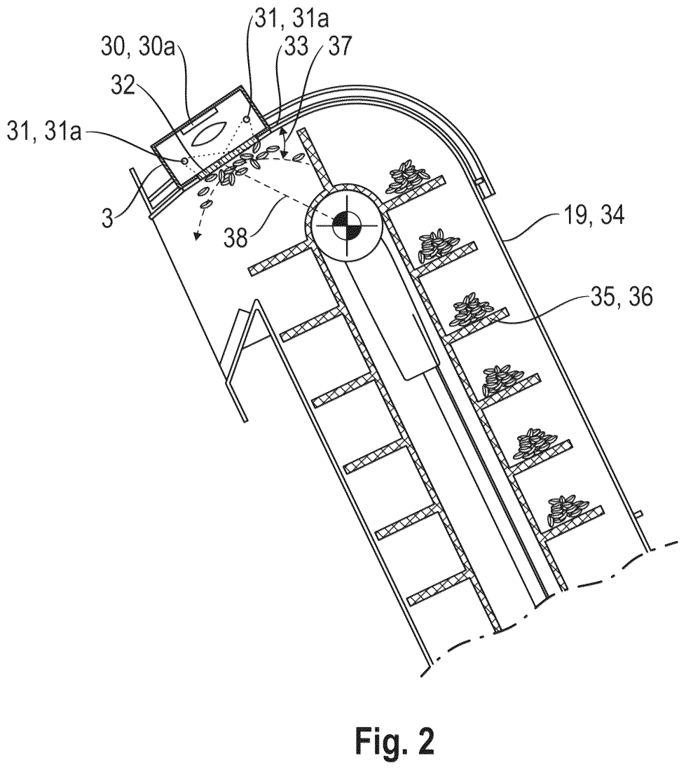

In this respect, the sensor device 3 (shown in FIG. 2) may comprise a light detector 30, which may be a CMOS (complementary metal-oxide-semiconductor) light sensor 30a, and an illumination device 31, which may be formed by a light-emitting diode assembly 31a.

In one or some embodiments, the illumination device 31 is configured to generate an illumination pulse for each image of an image series.

In addition to the internal configuration of the sensor device 3, there may also be one or more arrangements of the sensor device 3 within the harvester. In one or some embodiments, as may be seen from FIG. 2, the sensor device 3 has a transparent housing piece 32 which may be part of a locally flat wall surface 33 of a tubular harvested material guide 34. In one or some embodiments, the harvested material guide 34 may be the grain elevator 19. In other words, the transparent housing piece 32, which may serve to transmit both the light pulses and their respective reflection, may be part of the wall of the harvested material guide 34 and may neither be protruding nor be recessed relative to this wall. Such an arrangement may have the advantage that the sensor device 3 may not only be arranged particularly close to the flow of harvested material and its presence influences the guidance of the flow of harvested material on the harvested material transport path as little as possible, but it may also have the effect that the components of the flow of harvested material themselves cause its cleaning just from their impact on the transparent housing piece 32. Dust collection may therefore be effectively prevented.

In one or some embodiments, the harvested material guide 34 has a harvested material drive arrangement 35, such as harvested material paddles 36, which may move the main flow of harvested material in such a way that it is at least partially directed onto the transparent housing piece 32. In this way, it may be ensured that the harvested material of the main flow of harvested material is basically always present in the immediate vicinity of the transparent housing piece 32 or touching it. Therefore, the sensor device 3 may always be focused on a fixed distance, such as on a point basically directly beyond the transparent housing piece 32. In this regard, it may be ensured that the main flow of harvested material may be detected at this focused distance.

Thus, in one or some embodiments, the main flow of harvested material may be at least partially directed at an acute angle 37, such as less than 45°, or less than 22.5°, onto the transparent housing piece 32. An exemplary acute angle 37 is shown in FIG. 2. In this way, it is ensured that, on the one hand, a possible impact of the main flow of harvested material on the housing piece 32 does not significantly deflect it from its normal course and, on the other hand, a defined relative movement between the main flow of harvested material and the housing piece 32 takes place.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Combine harvester |
| 2 | Control assembly |
| 3 | Sensor device |
| 4 | Evaluation device |
| 5 | Visualization device |
| 6 | Cutting unit |
| 7 | Grain tank |
| 8 | Implements |
| 9 | Control device |
| 10 | Inclined conveyor |
| 11 | Threshing concave |
| 12 | Threshing units |
| 13 | Deflection drum |
| 14 | Separating device |
| 15 | Returns pan |
| 16 | Cleaning device |
| 17 | Screening levels |
| 18 | Fan |
| 19 | Grain elevator |
| 20 | Displayed value broken grain fraction |
| 21 | Displayed value non-grain fraction |
| 22 | Driver assistance system |
| 23 | Bar chart |
| 24 | Input unit |
| 25 | Adjustment assistant |
| 26 | Correction factor |
| 27 | Target broken grain fraction |
| 28 | Target non-grain fraction |
| 29 | Quality class |
| 30 | Light detector |
| 30a | Light sensor |
| 31 | Illumination device |
| 31a | Light emitting diode assembly |
| 32 | Housing piece |
| 33 | Wall surface |
| 34 | Harvested material guide |
| 35 | Harvested material guide assembly |
| 36 | Harvested material paddle |
| 37 | Angle |
| 38 | Harvested material guide cross section |
| 39 | Actual broken grain fraction |
| 40 | Actual non-grain fraction |
| 41 | Processor |
| 42 | Memory |
| 43 | Communication interface |
| B | Dialog step |
| C | Dialog step |
| D | Dialog step |
| D | Dialog step |

1. An agricultural harvester comprising:
a control assembly including an optical sensor device configured to record one or more images of a flow of harvested material;
an evaluation device configured to perform image analysis on the one or more images in order to determine, for the flow of harvested material, one or both of a value of broken grain fraction for display or a value of non-grain fraction for display;
a display configured to display the one or both of the value of the broken grain fraction for display or the value of the non-grain fraction for display; and
a driver assistance system comprising:
an input unit; and
an adjustment assistant configured to adjust a correction factor;
wherein the evaluation device is configured to determine the one or both of the value of the broken grain fraction for display or the value of the non-grain fraction for display using the correction factor that is adjusted; and
wherein the adjustment assistant is configured to determine the correction factor in a dialog with a plurality of dialog steps.

2. The agricultural harvester of claim 1, wherein the agricultural harvester comprises a self-propelled combine harvester.

3. The agricultural harvester of claim 1, wherein the evaluation device is configured to:
determine, from the one or more images, one or both of a raw broken grain fraction or a raw non-grain fraction; and
calculate, using the one or both of the raw broken grain fraction or the raw non-grain fraction, one or both of the value of the broken grain fraction for display or the value of non-grain fraction for display.

4. The agricultural harvester of claim 3, wherein the one or both of the raw broken grain fraction or the raw non-grain fraction corresponds to one or both of an area of the broken grain fraction or an area of the non-grain fraction of the one or more images; and
wherein one or both of the value of the broken grain fraction for display or the value of the non-grain fraction for display corresponds to one or both of a volume non-grain fraction or a volume broken grain fraction related to throughput of the flow of harvested material.

5. The agricultural harvester of claim 1, wherein the display is configured to display a bar chart; and
wherein the bar chart is a representation of the one or both of the value of the broken grain fraction for display or the value of the non-grain fraction for display.

6. The agricultural harvester of claim 5, wherein the display is configured to display both: the one or both of the value of the broken grain fraction for display or the value of the non-grain fraction for display; and the bar chart.

7. The agricultural harvester of claim 1, wherein the dialog of the adjustment assistant comprises an input of one or both of a target broken grain fraction or a target non-grain fraction.

8. The agricultural harvester of claim 7, wherein the dialog of the adjustment assistant comprises the input of both of the target broken grain fraction and the target non-grain fraction.

9. The agricultural harvester of claim 7, wherein the dialog of the adjustment assistant further comprises a query for selection of at least one target variable to be optimized; and
wherein the at least one target variable comprises one or both of an actual broken grain fraction or an actual non-grain fraction.

10. The agricultural harvester of claim 9, wherein the at least one target variable comprises both of the actual broken grain fraction and the actual non-grain fraction.

11. The agricultural harvester of claim 9, wherein the dialog of the adjustment assistant further comprises an evaluation of one or both of the actual broken grain fraction or the actual non-grain fraction of at least a part of the harvested material located in a grain tank.

12. The agricultural harvester of claim 11, wherein the dialog of the adjustment assistant comprises the evaluation of both of the actual broken grain fraction or the actual non-grain fraction of the at least a part of the harvested material located in the grain tank.

13. The agricultural harvester of claim 11, wherein the dialog of the adjustment assistant further comprises the dialog step indicative of a suggestion for the correction factor to be adjusted.

14. The agricultural harvester of claim 13, wherein the suggestion for the correction factor to be adjusted is based on an assessment of one or both of the actual broken grain fraction or the actual non-grain fraction of the at least a part of the harvested material located in the grain tank.

15. The agricultural harvester of claim 14, wherein the suggestion for the correction factor to be adjusted is based on the assessment of both of the actual broken grain fraction and the actual non-grain fraction of the at least a part of the harvested material located in the grain tank.

16. The agricultural harvester of claim 14, wherein the dialog of the adjustment assistant further comprises the dialog step in which an operator confirms the suggestion displayed for the correction factor to be adjusted;
wherein, responsive to the operator confirming the suggestion, the evaluation device is configured to use the suggestion for the correction factor to calculate the one or both of the value of the broken grain fraction for display or the value of the non-grain fraction for display; and
wherein, responsive to the operator rejecting the suggestion, the evaluation device is configured to reject using the suggested correction factor to calculate the one or both of the value of the broken grain fraction for display or the value of the non-grain fraction for display.

17. The agricultural harvester of claim 16, further comprising at least one control device and a plurality of implements;
wherein the plurality of implements comprise one or more of: at least one threshing unit; a separating device; or a cleaning device; and
wherein the control device is configured to perform one or both of control or regulation of the plurality of implements so that the one or both of the value of the broken grain fraction for display or the value of the non-grain fraction for display is approximated to one or both of the target broken grain fraction or the target non-grain fraction.

18. The agricultural harvester of claim 17, wherein the control device is configured to perform the one or both of control or regulation of the plurality of implements so that the both of the value of the broken grain fraction for display and the value of the non-grain fraction for display is, respectively, approximated both of the target broken grain fraction and the target non-grain fraction.

19. The agricultural harvester of claim 1, wherein the optical sensor device includes a transparent housing piece which is part of a wall surface of a tubular harvested material guide.

20. The agricultural harvester of claim 1, wherein the tubular harvested material guide comprises a grain elevator.
